(19) United States
(12) Patent Application Publication
(10) Pub. No.: US 2026/0317569 A1
(43) Pub. Date: Oct. 15, 2026

(54) INK COMPOSITION, METHOD FOR PRODUCING INK COMPOSITION, AND METHOD FOR PRODUCING COLOR FILTER

(71) Applicant: SHIN-ETSU CHEMICAL CO., LTD., Tokyo (JP)

(72) Inventors: Yoshihiro NOJIMA, Annaka-shi (JP); Shinji AOKI, Annaka-shi (JP); Kazuya TOBISHIMA, Annaka-shi (JP)

(73) Assignee: SHIN-ETSU CHEMICAL CO., LTD., Tokyo (JP)

(21) Appl. No.: 19/104,554

(22) PCT Filed: Aug. 8, 2023
(86) PCT No.: PCT/JP2023/028951

§ 371 Date: Feb. 18, 2025

(30) Foreign Application Priority Data
Aug. 23, 2022 (JP) 2022-132342

(51) Int. Cl. C09D 11/50; B41M 3/00; B41M 5/00; B82Y 20/00; B82Y 40/00; C09D 11/322; C09K 11/02; C09K 11/08; C09K 11/88; G02B 5/22

(52) U.S. Cl. CPC C09D 11/50; B41M 3/003; B41M 5/0047; C09D 11/322; C09K 11/025; C09K 11/0883; C09K 11/883; G02B 5/223; B82Y 20/00; B82Y 40/00

(57) ABSTRACT

An ink composition containing a quantum dot, the ink composition including a silsesquioxane polymer having the quantum dot copolymerized with silsesquioxane or a silsesquioxane polymer having the quantum dot copolymerized with alkoxysilane. The ink composition contains reliable quantum dots in which quantum dots at a high concentration can be dispersed without agglomeration.

### TECHNICAL FIELD

The present invention relates to an ink composition, a method for producing an ink composition, and a method for producing a color filter.

### BACKGROUND ART

Semiconductor crystal particles with nano-particle size are called quantum dots. Excitons generated by light absorption are confined in a nanosized region, so that the semiconductor crystal particles have discrete energy levels, and their band gap varies depending on the particle size. These effects make the fluorescence emission by quantum dots brighter, more efficient, and sharper than that by common fluorescent materials.

In addition, due to the nature of the varying band gap depending on the particle size, quantum dots have a characteristic that their emission wavelength is controllable, which makes them promising as a wavelength conversion material for solid-state illumination and displays. For example, using quantum dots as a wavelength conversion material in displays will provide a wider color range and lower power consumption than conventional fluorescent materials.

A previously proposed method for implementing quantum dots as a wavelength conversion material involves dispersing quantum dots in a resin material, followed by laminating the resin material containing the quantum dots with a transparent film and then incorporating the resin material into a backlight unit as a wavelength conversion film (Patent Document 1). Another previously proposed implementation for quantum dots is to use them as a color filter for application to image elements with high efficiency and excellent color reproducibility, where the quantum dots absorb blue monochromatic light from a backlight unit and emit red or green light to function as a color filter and a wavelength conversion material (Patent Document 2).

Micro-LED displays, in which the above backlight unit is replaced with a micro-sized LED array, have been a focus of attention. In micro-LED displays, it is required to form a color filter on micro-sized LEDs.

Recent continued miniaturization of the LED arrays has led to the need to make the pattern of quantum dots finer than before. In color filter applications, it is necessary to increase the light absorption by the color filter to prevent the excitation light, or blue monochromatic light, from leaking through the color filter. In order to increase the light absorption by the color filter, it is necessary to increase the concentration of quantum dots.

A previously proposed method for forming a quantum dot color filter on an LED array involves a lithography process using photosensitive materials (Patent Document 3). However, photolithography techniques generate large raw material losses because uncured portions are wasted, and they also require many production processes including baking, exposure, and development. For this reason, the use of inkjet techniques has recently been contemplated. Inkjet techniques generate less raw materials losses and require simple production processes consisting only of ejection and curing processes, which makes them cost-competitive.

### CITATION LIST

### Patent Literature

Patent Document 1: JP 2013-544018 A
Patent Document 2: JP 2017-021322 A
Patent Document 3: JP 2021-089347 A
Patent Document 4: JP 2016-518468 A
Patent Document 5: JP 2013-505346 A
Patent Document 6: JP 6283092 B2

### Non Patent Literature

Non Patent Document 1: Journal of Photopolymer Science and Technology, Vol 23, 2010, p115-119

### SUMMARY OF INVENTION

### Technical Problem

However, inkjet techniques eject ink through a narrow nozzle, and the nozzle diameter becomes narrower to form a fine pattern of 100 μm or less required for applications such as for use in micro-LEDs, imposing great limitations on the ink characteristics in order to ensure stable ejection and pattern reproducibility. For example, there are parameters such as the viscosity of the ink, evaporation rate of the ink, concentration of quantum dots, which are solids in the ink, and agglomeration and sedimentation rates of quantum dots in the resin solution. If these parameters are not within the respective appropriate ranges according to apparatus and ejection conditions, problems may arise such as the increased possibility of clogging in the nozzle portion or the ink supply line, and changes and variations in ejection characteristics during continuous ejection and the resultant variations in pixel-to-pixel characteristics.

Generally, polar resin materials such as acrylic and silicone resins are dispersed in polar solvents such as PGMEA and PGME, so that polar resin materials have poor compatibility with hydrophobic quantum dots, which are basically hydrophobic, leading to a major problem of agglomeration. Agglomeration causes blockage in the inkjet nozzle or supply line, which is a major process problem.

To accommodate miniaturized devices, attempts have been made to use smaller-diameter nozzles for ink application by inkjet techniques. However, reducing the size of the nozzle leads to problems such as clogging and unstable ejection. In addition, because of the hydrophobic nature of quantum dots, non-polar solvents are used, but common non-polar solvents, such as toluene and hexane, have low boiling points and are easy to evaporate, which increases the likelihood of nozzle blockage due to solvent evaporation at the nozzle tip. This phenomenon is particularly pronounced with higher quantum dot concentrations.

High ink viscosity will cause problems such as the increased possibility of clogging in the nozzle portion or ink supply line, and changes and variations in ejection characteristics during continuous ejection and the resultant variations in pixel-to-pixel characteristics. Thus, the use of low-viscosity ink is essential for stable pattern formation. However, an increased content of curable resin and quantum dots in an ink composition generally leads to an increased viscosity of the ink composition, which may cause failures during processes.

Further, since the quantum dots in the resin composition after the pattern formation are present in the resin material, detachment of the ligands is likely to occur unlike the environment in the solution, and such changes over time cause a problem of degradation in emission characteristics.

To deal with this problem, various attempts have been made for improving the dispersibility of quantum dots in polar solvents and resin materials or enhancing the stability of quantum dots, including surface coating of quantum dots (Patent Document 4), encapsulation of quantum dots (Patent Document 5), and the use of polyhedral oligomeric silsesquioxane ligands (Patent Document 6). However, it is difficult to achieve the dispersibility of quantum dots in resin materials and, especially at high concentrations of quantum dots of 10% by mass or more, the inhibition of agglomeration and the stability of quantum dots, all at the same time.

The present invention has been made to address the above problems and aims to provide an ink composition containing reliable quantum dots in which quantum dots at a high concentration can be dispersed without agglomeration.

### Solution to Problem

The present invention has been made to achieve the above object and provides an ink composition containing a quantum dot, the ink composition including a silsesquioxane polymer having the quantum dot copolymerized with silsesquioxane or a silsesquioxane polymer having the quantum dot copolymerized with alkoxysilane.

Such an ink composition can provide an ink composition containing a reliable quantum dot in which a quantum dot at a high concentration can be dispersed without agglomeration.

Preferably, the quantum dot has surface modified with a silane coupling agent.

Such an ink composition can provide an ink composition a containing reliable quantum dot in which a silsesquioxane polymer having the quantum dot copolymerized with silsesquioxane or a silsesquioxane polymer having the quantum dot copolymerized with alkoxysilane can be easily formed and in which a quantum dot at a high concentration can be dispersed without agglomeration.

Preferably, the alkoxysilane includes two or more alkoxysilanes with different functional groups.

Such an ink composition can provide an ink composition containing a reliable quantum dot that allows for controlling the degree of crosslinking of the silsesquioxane polymer and allows for controlling the viscosity of the ink composition and in which a quantum dot at a high concentration can be dispersed without agglomeration. In addition, the viscosity of the ink composition can be adjusted according to production processes.

Preferably, the alkoxysilane includes at least two or more alkoxysilanes selected from trialkoxysilane, monoalkoxysilane, and dialkoxysilane, and the ink composition has a viscosity of equal to or less than 1500 mPa·s.

Such an ink composition can provide an ink composition containing a reliable quantum dot that allows for controlling the degree of crosslinking of the silsesquioxane polymer and allows for controlling the viscosity of the ink composition and in which a quantum dot at a high concentration can be dispersed without agglomeration. In addition, the viscosity of the ink composition can be adjusted according to production processes.

Preferably, the silane coupling agent has one or more selected from an amino group, a thiol group, a carboxyl group, a phosphino group, a phosphine oxide group, and an ammonium ion.

Such an ink composition can provide an ink composition containing a reliable quantum dot in which a silsesquioxane polymer having the quantum dot copolymerized with silsesquioxane or a silsesquioxane polymer having the quantum dot copolymerized with alkoxysilane can be easily formed and in which a quantum dot at a high concentration can be dispersed without agglomeration.

Preferably, the silsesquioxane has one or more reactive substituents selected from a vinyl group, an acrylic group, a methacrylic group, a hydroxyl group, a phenolic hydroxyl group, an epoxy group, a glycidyl group, and a thiol group as functional groups.

Such an ink composition can provide an ink composition containing reliable a quantum dot in which a silsesquioxane polymer having the quantum dot copolymerized with silsesquioxane or a silsesquioxane polymer having the quantum dot copolymerized with alkoxysilane can be easily formed and in which a quantum dot at a high concentration can be dispersed without agglomeration.

Preferably, the alkoxysilane has one or more reactive substituents selected from a vinyl group, an acrylic group, a methacrylic group, a hydroxyl group, a phenolic hydroxyl group, an epoxy group, a glycidyl group, and a thiol group as functional groups.

Such an ink composition can provide an ink composition containing reliable a quantum dot in which a silsesquioxane polymer having the quantum dot copolymerized with silsesquioxane or a silsesquioxane polymer having the quantum dot copolymerized with alkoxysilane can be easily formed and in which a quantum dot at a high concentration can be dispersed without agglomeration.

In another aspect, the present invention provides a method for producing a color filter, including ejecting the aforementioned ink composition onto a substrate by an inkjet method to form a color filter.

Such a method for producing a color filter can form a color filter in an easy and precise manner by smoothly ejecting an ink composition containing a reliable quantum dot in which a quantum dot at a high concentration can be dispersed without agglomeration, onto a substrate by an inkjet method without causing a clogging of the nozzle.

In still another aspect, the present invention provides a method for producing an ink composition, including steps of: providing a quantum dot; providing alkoxysilane; and making the alkoxysilane into silsesquioxane attached to a surface of the quantum dot to form a copolymer comprising the quantum dot and the silsesquioxane.

Such a method for producing an ink composition can produce an ink composition containing a reliable quantum dot in which a quantum dot at a high concentration can be dispersed without agglomeration, in an easy and reliable manner.

Preferably, the step of providing the quantum dot includes steps of: forming a core; and forming a shell around the core.

Such a method for producing an ink composition can produce core-shell quantum dots in an easy and reliable manner and provide an ink composition containing a reliable quantum dot in which a quantum dot at a high concentration can be dispersed without agglomeration.

Preferably, the step of forming the copolymer includes steps of: surface-modifying the quantum dot with a silane coupling agent; and attaching the silsesquioxane to the surface of the quantum dot via the silane coupling agent.

Such a method for producing an ink composition can provide an ink composition containing a reliable quantum dot in which a silsesquioxane polymer having the quantum dot copolymerized with silsesquioxane or a silsesquioxane polymer having the quantum dot copolymerized with alkoxysilane can be easily formed and in which a quantum dot at a high concentration can be dispersed without agglomeration.

### Advantageous Effects of Invention

To achieve the above object, the present invention can provide an ink composition containing reliable quantum dots in which quantum dots at a high concentration can be dispersed without agglomeration by curing, through crosslinking reactions, a silsesquioxane polymer having the quantum dot copolymerized with silsesquioxane or having the quantum dot copolymerized with alkoxysilane.

The inventive ink composition can be an ink composition containing a reliable quantum dot in which quantum dots at a high concentration can be dispersed without agglomeration.

The inventive method for producing an ink composition can produce an ink composition containing a reliable quantum dot in which a quantum dot at a high concentration can be dispersed without agglomeration.

The inventive method for producing a color filter can form a color filter in an easy and precise manner by smoothly ejecting an ink composition containing a reliable quantum dot in which a quantum dot at a high concentration can be dispersed without agglomeration, onto a substrate by an inkjet method without causing a clogging of the nozzle.

### DESCRIPTION OF EMBODIMENTS

Hereinafter, embodiments of the present invention will be described. However, the present invention is not limited to the following description.

As described above, there has been an objective to obtain an ink composition for inkjet applications in which quantum dots at a high concentration can be dispersed without agglomeration and that thus contains reliable quantum dots and enables stable ejection.

The present inventors have earnestly studied to achieve the above object and consequently found an ink composition including a silsesquioxane polymer having quantum dots copolymerized with silsesquioxane or a silsesquioxane polymer having quantum dots copolymerized with alkoxysilane. This finding has led to the completion of the present invention.

### (Quantum Dots)

In the present invention, the composition of and method of producing quantum dots are not limited, and any quantum dots may be selected according to the purpose.

### (Composition of Quantum Dots)

Example compositions of the quantum dots include group II-IV semiconductors, group III-V semiconductors, group II-VI semiconductors, group I-III-VI semiconductors, group II-IV-V semiconductors, group IV semiconductors, and perovskite semiconductors.

### (Structure of Quantum Dots)

The quantum dots may have either a core-only structure or a core-shell structure.

### (Core Material)

Specific examples of core materials include CdSe, CdS, CdTe, InP, InAs, InSb, AlP, AlAs, AlSb, ZnSe, ZnS, ZnTe, Zn₃P₂, GaP, GaAs, GaSb, CuInSe₂, CuInS₂, CuInTe₂, CuGaSe₂, CuGaS₂, CuGaTe₂, CuAlSe₂, CuA₁S₂, CuAlTe₂, AgInSe₂, AgInS₂, AgInTe, AgGaSe₂, AgGaS₂, AgGaTe₂, PbSe, PbS, PbTe, Si, Ge, graphene, CsPbCl₃, CsPbBr₃, CsPbI₃, CH₃NH₃PbCl₃, and mixed crystals of these substances as well as these substances with added dopants.

### (Shell Material)

Examples of shell materials include Zno, ZnS, ZnSe, ZnTe, CdS, CdSe, CdTe, AlN, AlP, AlAs, AlSb, GaN, GaP, GaAs, GaSb, InN, InP, InAs, AlSb, BeS, BeSe, BeTe, MgS, MgSe, MgTe, PbS, PbSe, PbTe, SnS, SnSe, SnTe, CuF, CuCl, CuBr, CuI, and mixed crystals of these substances.

### (Shape of Quantum Dots)

The quantum dots may be spherical, cubic, or rod-shaped. The shape of the quantum dots is not limited and can be freely selected.

### (Average Particle Size of Quantum Dots)

The particle size of the quantum dots can be selected as suited for the intended wavelength range.

Desirably, the average particle size of the quantum dots is equal to or less than 20 nm. If the average particle size is equal to or greater than this value, the quantum size effect will not occur, resulting in a significant decrease in emission efficiency and an inability to control the band gap based on the particle size.

The particle size of quantum dots can be calculated from an average of the maximum unidirectional diameters, i.e., Feret's diameters, of 20 or more particles, as measured from particle images obtained by a transmission electron microscope (TEM). Of course, the method for measuring the average particle diameter is not limited to this, and other methods can be used.

### (Ligands)

Ligands may be present on the surface of the quantum dots, and the ligands preferably contain aliphatic hydrocarbons for dispersibility. Examples of such ligands include oleic acid, stearic acid, palmitic acid, myristic acid, lauryl acid, decanoic acid, octanoic acid, oleylamine, stearyl (octadecyl) amine, dodecyl (lauryl) amine, decylamine, octylamine, octadecanethiol, hexadecanethiol, tetradecanethiol, dodecanethiol, decanethiol, octanethiol, trioctylphosphine, trioctylphosphine oxide, triphenylphosphine, triphenylphosphine oxide, tributylphosphine, and tributylphosphine oxide. These ligands may be used alone or in mixtures thereof.

### (Silane Coupling Agent)

Preferably, the quantum dots have surface-modified with a silane coupling agent.

Preferably, the silane coupling agent has an amino group, a thiol group, a carboxyl group, a phosphino group, a phosphine oxide group, or an ammonium ion.

Examples of such silane coupling agents include 3-aminopropyltriethoxysilane, 3-aminopropyltrimethoxysilane, aminophenyltrimethoxysilane, N-(2-aminoethyl)-3-aminopropyltriethoxysilane, 3-mercaptopropyltriethoxysilane, 3-mercaptopropyltrimethoxysilane, 3-mercaptopropyl(dimethoxy)methylsilane, triethoxysilylpropylmaleamic acid, [(3-triethoxysilyl)propyl]succinic anhydride, X-12-1135 (available from Shin-Etsu Chemical Co., Ltd.), diethylphosphatoethyltriethoxysilane, 3-trihydroxypropyl methylphosphonate sodium salt, and trimethyl[3-(trimethoxysilyl)propyl]ammonium chloride.

The ink composition according to the present invention includes a silsesquioxane polymer having the quantum dot copolymerized with silsesquioxane or a silsesquioxane polymer having the quantum dot copolymerized with alkoxysilane.

(Silsesquioxane Polymer Having Quantum Dots Copolymerized with Silsesquioxane)

In one embodiment of the present invention, the quantum dots surface-modified with a silane coupling agent are copolymerized with silsesquioxane. The copolymerization method is not limited.

For example, the surface-modified quantum dots and silsesquioxane can be copolymerized by mixing them in a mixed solvent of toluene and ethanol and initiating the reaction with the addition of a small amount of water and a catalyst.

The type of catalyst is not limited, and acids or alkalis can be used.

Examples of the catalyst include formic acid, hydrochloric acid, nitric acid, acetic acid, maleic acid, aqueous ammonia, sodium hydroxide solution, and tetramethylammonium hydroxide.

The structure of silsesquioxane is not limited, and any structure such as a cage structure, a ladder structure, and a random structure can be selected as suited for the purpose. A random structure is preferred in terms of dispersibility and uniformity of quantum dots.

The functional groups contained in the silsesquioxane are not limited and may be substituted as suited for the purpose. Substituents that can undergo polymerization and crosslinking reactions are particularly preferred in terms of curability.

Examples of the functional groups of silsesquioxane include vinyl, acrylic, methacrylic, hydroxyl, phenolic hydroxyl, epoxy, glycidyl, and thiol groups.

(Silsesquioxane Polymer Having Quantum Dots Copolymerized with Alkoxysilane)

In another embodiment of the present invention, quantum dots surface-modified with a silane coupling agent are copolymerized with alkoxysilane to form a silsesquioxane polymer. The copolymerization method is not limited. A known method for synthesizing silsesquioxane is disclosed in Non Patent Document 1.

For example, a silsesquioxane polymer can be obtained by mixing the surface-modified quantum dots and alkoxysilane in a mixed solvent of toluene and ethanol and initiating the reaction with the addition of a small amount of water and a catalyst.

The type and amount of catalyst added is not limited, and acids or alkalis can be used.

Examples of the catalyst include formic acid, hydrochloric acid, nitric acid, acetic acid, aqueous ammonia, and tetramethylammonium hydroxide.

The silane coupling agent is not limited and can be selected as suited for the intended resin characteristics. Preferably, the silane coupling agent has a vinyl group, an allyl group, a glycidyl group, a phenyl group, an acrylic group, a methacrylic group, or a thiol group as functional groups.

Alkoxysilane with two or more functional groups rather than only one functional group may also be used.

Examples of the silane coupling agent include trimethoxyvinylsilane, triethoxyvinylsilane, trimethoxy (4-vinylphenyl) silane, allyltriethoxysilane, allyltrimethoxysilane, triethoxy (3-glycidyloxypropyl) silane, 3-glycidyloxypropyltrimethoxysilane, [8-(glycidyloxy)-n-octyl]trimethoxysilane, KBM-573 (available from Shin-Etsu Chemical Co., Ltd.), (3-methacryloyloxypropyl)triethoxysilane, (3-methacryloyloxypropyl)trimethoxysilane, 3-(trimethoxysilyl)propyl acrylate, 3-mercaptopropyltriethoxysilane, and 3-mercaptopropyltrimethoxysilane.

The above silane coupling agents are preferred because they have high coordinating properties to quantum dots and provide high affinity between silsesquioxane and quantum dots.

The above silane coupling agents are preferred also because the use of any of them allows for controlling the polarity of the quantum dots and silsesquioxane polymer and provides good compatibility with any solvent for the ink composition.

The alkoxysilane may include not only trialkoxysilanes but also dialkoxysilanes or monoalkoxysilanes. Trialkoxysilanes, dialkoxysilanes, and monoalkoxysilanes may have the same or different functional groups. The inclusion of dialkoxysilanes or monoalkoxysilanes allows for controlling the degree of crosslinking of the silsesquioxane resulting from the copolymerization, which in turn allows for controlling the viscosity of the resulting resin composition, making it possible to adjust the viscosity according to production processes. For example, during the synthesis of silsesquioxane, a precursor trialkoxysilane may be mixed with a monoalkoxysilane that has a long-chain alkyl group or a bulky substituent to thereby limit the crosslinking reactions and lower the viscosity.

Also, mixing a trialkoxysilane with a dialkoxysilane or a monoalkoxysilane can reduce the degree of crosslinking and lower the viscosity. The type and ratio of these alkoxysilanes are not limited and can be selected as suited for the purpose.

The viscosity of the ink composition is preferably equal to or less than 1500 mPa·s, particularly preferably equal to or less than 1000 mPa·s. While there is no particular lower limit to the viscosity, it is equal to or greater than 1 mPa·s, for example. For example, the viscosity of the ink composition is measured at 25° C. with a rotational viscometer (DV-I, available from Brookfield Engineering Laboratories, Inc.).

Examples of functional groups of the alkoxysilane include one or more reactive substituents selected from vinyl, acrylic, methacrylic, hydroxyl, phenolic hydroxyl, epoxy, glycidyl, and thiol groups.

The method for producing an ink composition according to the present invention includes: a step 1 of providing quantum dots; a step 2 of providing alkoxysilane; and a step 3 of making the alkoxysilane into silsesquioxane attached to the surface of the quantum dots to form a copolymer including the quantum dots and the silsesquioxane.

Preferably, the step 1 of providing quantum dots includes: a step 1-1 of forming a core; and a step 1-2 of forming a shell around the core.

Preferably, the step 3 of forming a copolymer includes: a step 3-1 of surface-modifying the quantum dots with a silane coupling agent; and a step 3-2 of attaching the silsesquioxane to the surface of the quantum dots via the silane coupling agent.

The inventive ink composition may contain a copolymer of the surface-treated quantum dots and silsesquioxane, a crosslinking agent, and a polymerization initiator, and may additionally contain a solvent, an antioxidant, a light-scattering agent, etc.

### (Crosslinking Agent)

Preferably, the crosslinking agent has two or more functional groups that react with the polymerizable substituents contained in the copolymer of the quantum dots and silsesquioxane. The amount of crosslinking agent added and the combination of these functional groups are not limited and can be selected as suited for the intended curing characteristics.

Radical polymerizable substituents include vinyl, acrylic, methacrylic, and thiol groups, all of which can be suitably used.

Cationic polymerizable substituents include hydroxyl, phenolic hydroxyl, epoxy, glycidyl, oxetanyl, and isocyanate groups, all of which can be suitably used.

Examples of the crosslinking agent include dipentaerythritol hexaacrylate, octavinylsilsesquioxane, 2,4,6,8-tetramethyl-2,4,6,8-tetravinylcyclotetrasiloxane, 2,4,6-trimethyl-2,4,6-tribinylcyclotrisiloxane, triallylisocyanurate, trimethylolpropane triacrylate, and N,N′-methylenebis(acrylamide).

### (Scatterers)

The scatterers may be inorganic particles, organic particles, or the like, which can be selected as suited for the purpose. The size and amount of particles added are desirably adjusted to optimize the light extraction efficiency based on the wavelength or emission wavelength of the light source used and the structure of the wavelength conversion material.

Examples of inorganic particles include silica, zirconia, alumina, barium titanate, and barium sulfate. Examples of organic particles include PMMA, polystyrene, and polycarbonate.

### (Polymerization Initiator)

The inventive ink composition preferably contains a polymerization initiator.

Polymerization initiators include thermal initiators and photoinitiators, both of which can be suitably used according to the polymerization method.

Radical photoinitiators include Irgacure® series commercially available from BASF, including, for example, Irgacure 290, Irgacure 651, Irgacure 754, Irgacure 184, Irgacure 2959, Irgacure 907, Irgacure 369, Irgacure 379, Irgacure 819, and Irgacure 1173.

Another example is Darocure® series, including, for example, TPO and Darocure 1173.

Alternatively, the inventive ink composition may contain a known radical thermal initiator or cationic photoinitiator, with no particular limitations.

The polymerization initiator content is preferably 0.1 to 10 parts by mass, more preferably 0.2 to 5 parts by mass, relative to 100 parts by mass of the polymer to be added.

### (Solvent)

The inventive ink composition may contain a solvent to improve its applicability. In terms of compatibility with quantum dots, the solvent is preferably an organic solvent, examples of which include ketones, alkylene glycol ethers, alcohols, and aromatic compounds.

From the ketone group, acetone, methyl ethyl ketone, cyclohexanone, etc. may be used. From the alkylene glycol ether group, methyl cellosolve (ethylene glycol monomethyl ether), butyl cellosolve (ethylene glycol monobutyl ether), methyl cellosolve acetate, ethyl cellosolve acetate, butyl cellosolve acetate, ethylene glycol monopropyl ether, ethylene glycol monohexyl ether, ethylene glycol dimethyl ether, diethylene glycol ethyl ether, diethylene glycol diethyl ether, propylene glycol monomethyl ether, propylene glycol monoethyl ether, propylene glycol monopropyl ether, propylene glycol monobutyl ether, propylene glycol monomethyl ether acetate, diethylene glycol methyl ether acetate, diethylene glycol ethyl ether acetate, diethylene glycol propyl ether acetate, diethylene glycol isopropyl ether acetate, diethylene glycol butyl ether acetate, diethylene glycol tertiary butyl ether acetate, triethylene glycol methyl ether acetate, triethylene glycol ethyl ether acetate, triethylene glycol propyl ether acetate, triethylene glycol isopropyl ether acetate, triethylene glycol butyl ether acetate, triethylene glycol tertiary butyl ether acetate, etc. may be used. From the alcohol group, methyl alcohol, ethyl alcohol, isopropyl alcohol, n-butyl alcohol, 3-methyl-3-methoxybutanol, etc. may be used. From the aromatic solvent group, benzene, toluene, and xylene may be used.

In inkjet methods, volatilization of the solvent at the nozzle tip causes the solid components such as quantum dots to be solidified and block the nozzle tip, resulting in unstable ejection. Accordingly, the solvent is preferably a less volatile one, particularly preferably an organic solvent with a boiling point of 100° C. or higher. Suitable examples of such solvents include propylene glycol monomethyl ether acetate, propylene glycol monomethyl ether, ethylene glycol, and propylene glycol.

### (Content of Quantum Dots)

The content of quantum dots can be adjusted as suited for the intended luminescence characteristics. Preferably, the concentration of quantum dots is adjusted such that the absorption for the excitation light is equal to or greater than 90%. The optimum concentration varies depending on the characteristics of the quantum dots, but is particularly preferably equal to or greater than 10 wt. %.

The method for producing a color filter according to the present invention is to form a color filter by ejecting the inventive ink composition onto a substrate by an inkjet method.

### (Inkjet Apparatus, Method, Substrate)

The ink composition containing quantum dots produced by the above method can be applied onto a substrate using an inkjet apparatus to obtain a wavelength conversion material for color filter applications.

The inkjet method is not limited, and a piezoelectric, bubble, valve, or other method can be selected as suited for the ink characteristics.

The structure of the inkjet apparatus is also not limited and may have either a single or multi-nozzle structure, for example.

The substrate can be selected as suited for the purpose. Example substrates include silicon wafers, glass substrates, resin plates, and resin films. The substrate may be surface-treated with a silane coupling agent or other surface treatment agent to improve the pattern adhesion.

### (Curing of the Ink Composition)

The inventive ink composition may be a mixture of a silsesquioxane polymer and a curable resin. In this case, the ink composition is ejected onto the substrate, and then the resin layer is cured. The resin layer can be cured by UV irradiation for photocurable resins, or by heating the entire substrate for thermosetting resins. Preferably, curing conditions are adjusted according to the resin material and pattern shape.

Preferably, the thermosetting resin is an acrylic resin with a (meth)acryloyl group in the side chain or a silicone resin containing an acid-crosslinkable group. Suitable polymers include polymers derived from acrylic acid, methacrylic acid, acrylic ester, and methacrylic ester or copolymers combining some of these polymers, polymers having glycidyl (meth)acrylate in the repeating unit, and polymers including a siloxane, urethane, silphenylene, norbornene, fluorene, or isocyanurate backbone. Any polymer may be selected as suited for the application. Examples include acrylic resins, alkyd resins, melamine resins, epoxy resins, silicone resins, polyvinyl alcohols, polyvinyl pyrrolidones, polyimide precursors such as polyamides, polyamide-imides, and polyimides and their esterification products, and reaction products of tetracarboxylic dianhydride and diamine. In addition, polymerizable substituents are introduced into these polymers, so that they can be cured by being combined with a polymerization initiator. Radical polymerizable substituents include vinyl, acrylic, methacrylic, and thiol groups, all of which can be suitably used. Cationic polymerizable substituents include hydroxyl, phenolic hydroxyl, epoxy, glycidyl, oxetanyl, and isocyanate groups, all of which can be suitably used.

### EXAMPLES

The present invention is now further detailed with reference to Examples and Comparative Examples, though the present invention is not limited to these examples. In Examples, InP/ZnSe/ZnS core-shell quantum dots were used as the quantum dot material.

### (Step 1 of Providing Quantum Dots)

### (Step 1-1 of Forming a Core: Quantum Dot Core Synthesis Step)

To a flask were added 0.23 g (0.9 mmol) of palmitic acid, 0.088 g (0.3 mmol) of indium acetate, and 10 ml of 1-octadecene. The mixture was heated with stirring at 100° C. under reduced pressure, and then degassed for 1 hour while dissolving the raw materials.

Thereafter, nitrogen was purged into the flask, and 0.75 mL (0.15 mmol) of 0.2 M solution prepared by mixing tristrimethylsilylphosphine with trioctylphosphine was added, followed by raising the temperature to 300° C., and it was confirmed that the solution changed from yellow to red and the core particles were formed.

### (Step 1-2 of Forming a Shell Around the Core: Quantum Dot Shell Layer Synthesis Step)

Then, 2.85 g (4.5 mmol) of zinc stearate and 15 mL of 1-octadecene were added to another flask. The mixture was heated with stirring to 100° C. under reduced pressure, and then degassed for 1 hour while being dissolved to prepare a 0.3 M solution of octadecene zinc stearate. Then, 3.0 mL (0.9 mmol) of this solution was added to the reaction solution after the core synthesis, followed by cooling the reaction solution to 200° C.

Next, 0.474 g (6 mmol) of selenium and 4 mL of trioctylphosphine were added to another flask and dissolved by heating to 150° C. to prepare a 1.5 M solution of selenium trioctylphosphine. While raising the temperature of the reaction solution after the core synthesis step, which had been cooled to 200° C., to 320° C. over 30 minutes, a total of 0.6 mL (0.9 mmol) of the selenium trioctylphosphine solution was added, in 0.1 mL steps, to the reaction solution, which was then held at 320° C. for 10 minutes and cooled to room temperature.

To this solution, 0.44 g (2.2 mmol) of zinc acetate was added and dissolved by heating with stirring to 100° C. under reduced pressure. The flask was purged again with nitrogen, and the temperature was raised to 230° C., followed by adding 0.98 mL (4 mmol) of 1-dodecanethiol and holding the solution for 1 hour.

The resulting solution was cooled to room temperature to prepare an InP/ZnSe/ZnS solution containing core-shell quantum dots.

### (Step 2 of Providing Alkoxysilane)

6 mL of (3-mercaptopropyl)triethoxysilane, 1 mL of trimethoxy (3, 3,3-trifluoropropyl) silane and 3 mL of phenyltrimethoxysilane, and 6 mL of (3-mercaptopropyl)triethoxysilane, 2 mL of phenyltrimethoxysilane and 2 mL of ethoxytrimethylsilane, and 6 mL of (3-methacryloyloxypropyl)trimethoxysilane, 2 mL of phenyltrimethoxysilane and 2 mL of ethoxytrimethylsilane, and 7 mL of 3-aminopropyltrimethoxysilane, 1 mL of dodecyltrimethoxysilane and 2 mL of ethoxytrimethylsilane, and 10 mL of (3-methacryloyloxypropyl)trimethoxysilane were provided.

(Step 3 of Making Alkoxysilane into Silsesquioxane Attached to the Surface of the Quantum Dots to Form a Copolymer Including the Quantum Dots and Silsesquioxane)
(Step 3-1 of Surface-Modifying the Quantum Dots with a Silane Coupling Agent: Surface Treatment of the Quantum Dots)

After completion of the reaction, the solution was cooled to room temperature, and ethanol was added to precipitate the reaction solution, which was then centrifuged to remove the supernatant.

A similar purification was performed again, followed by dispersing the solution in toluene.

The toluene solution containing the quantum dots was poured into a nitrogen-purged flask.

To this solution was added 0.24 mL (1.0 mmol) of (3-mercaptopropyl)triethoxysilane, followed by stirring the solution at room temperature for 24 hours.

### (Step 3-2 of Attaching Silsesquioxane to the Surface of Quantum Dots Via a Silane Coupling Agent (1): Copolymerization 1 of Quantum Dots and Silsesquioxane)

To a nitrogen-purged flask were added 6 mL of (3-mercaptopropyl)triethoxysilane, 1 mL of trimethoxy (3, 3,3-trifluoropropyl) silane, 3 mL of phenyltrimethoxysilane, and the solution containing the surface-treated quantum dots so as to give a solids concentration of 20 parts by mass. The solution was further mixed with 20 mL of toluene and 10 mL of methanol, followed by adding 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

The system was evacuated at 60° C. for 180 minutes to distill off the solvent from the system, resulting in a copolymer (1) of quantum dots and silsesquioxane.

### (Step 3-2 of Attaching Silsesquioxane to the Surface of Quantum Dots Via a Silane Coupling Agent (2): Copolymerization 2 of Quantum Dots and Silsesquioxane)

To a nitrogen-purged flask were added 6 mL of (3-mercaptopropyl)triethoxysilane, 2 mL of phenyltrimethoxysilane, 2 mL of ethoxytrimethylsilane, and the solution containing the surface-treated quantum dots so as to give a solids concentration of 20 parts by mass. The solution was further mixed with 20 mL of toluene and 10 mL of methanol.

To this solution was added 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

Then, nitrogen was sent into the system at 40° C. to distill off the solvent, resulting in a copolymer (2) of quantum dots and silsesquioxane.

### (Step 3-2 of Attaching Silsesquioxane to the Surface of Quantum Dots Via a Silane Coupling Agent (3): Copolymerization 3 of Quantum Dots and Alkylsilane)

To a nitrogen-purged flask were added 6 mL of (3-methacryloyloxypropyl)trimethoxysilane, 2 mL of phenyltrimethoxysilane, 2 mL of ethoxytrimethylsilane, and the solution containing the surface-treated quantum dots so as to give a solids concentration of 20 parts by mass. The solution was further mixed with 20 mL of toluene and 10 mL of methanol.

To this solution was added 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

Then, nitrogen was sent into the system at 40° C. to distill off the solvent, resulting in a copolymer (3) of quantum dots and silsesquioxane.

### (Step 3-2 of Attaching Silsesquioxane to the Surface of Quantum Dots Via a Silane Coupling Agent (4): Copolymerization 4 of Quantum Dots and Alkylsilane)

To a nitrogen-purged flask were added 7 mL of 3-aminopropyltrimethoxysilane, 1 mL of dodecyltrimethoxysilane, 2 mL of ethoxytrimethylsilane, and the solution containing the surface-treated quantum dots so as to give a solids concentration of 20% by mass. The solution was further mixed with 20 mL of toluene and 10 mL of methanol.

To this solution was added 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

Then, nitrogen was sent into the system at 40° C. to distill off the solvent, resulting in a copolymer (4) of quantum dots and silsesquioxane.

### (Step 3-2 of Attaching Silsesquioxane to the Surface of Quantum Dots Via a Silane Coupling Agent (5): Copolymerization 5 of Quantum Dots and Alkylsilane)

To a nitrogen-purged flask were added 10 mL of (3-methacryloyloxypropyl)trimethoxysilane and the solution containing the surface-treated quantum dots so as to give a solids concentration of 20 parts by mass. The solution was further mixed with 20 mL of toluene and 10 mL of methanol.

To this solution was added 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

Then, nitrogen was sent into the system at 40° C. to distill off the solvent, resulting in a copolymer (5) of quantum dots and silsesquioxane.

### (Synthesis of Silsesquioxane Crosslinking Agent)

To a nitrogen-purged flask were added 10 mL of trimethoxyvinylsilane, 20 mL of toluene, and 10 mL of methanol, followed by adding 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

The system was then evacuated at 60° C. for 2 hours to distill off the solvent.

Remaining in the flask was silsesquioxane with vinyl groups (crosslinking agent (1)).

To a nitrogen-purged flask were added 10 mL of (3-methacryloyloxypropyl) trimethoxysilane, 20 mL of toluene, and 10 mL of methanol, followed by adding 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

The system was then evacuated at 60° C. for 2 hours to distill off the solvent.

Remaining in the flask was silsesquioxane with methacrylic groups (crosslinking agent (2)).

To a nitrogen-purged flask were added 10 mL of (3-glycidyloxypropyl)trimethoxysilane, 20 mL of toluene, and 10 mL of methanol, followed by adding 4.0 mL of 1.0 N hydrochloric acid dropwise and portionwise with stirring at room temperature.

After the dropping, the solution was stirred at room temperature for 60 minutes, and further reacted under reflux for 60 minutes with the solution temperature set at 60° C.

The system was then evacuated at 60° C. for 2 hours to distill off the solvent.

Remaining in the flask was silsesquioxane with glycidyl groups (crosslinking agent (3)).

### Example 1

The quantum dot/silsesquioxane copolymer (1) was weighed to contain 20 wt. % quantum dots in terms of the ratio of nonvolatile components, and octavinylsilsesquioxane was added as a crosslinking agent such that the molar ratio of mercapto groups in the copolymer to vinyl groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 1429 mPa·s as measured with a rotational viscometer (at 25° C.).

### Example 2

The quantum dot/silsesquioxane copolymer (1) was weighed to contain 20 wt. % quantum dots in terms of the ratio of nonvolatile components, and the crosslinking agent (1) was added as a crosslinking agent such that the molar ratio of mercapto groups in the copolymer to vinyl groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 1047 mPa·s as measured with a rotational viscometer (at 25° C.).

### Example 3

The quantum dot/silsesquioxane copolymer (1) was weighed to contain 20 wt. % quantum dots in terms of the ratio of nonvolatile components, and the crosslinking agent (2) was added as a crosslinking agent such that the molar ratio of mercapto groups in the copolymer to methacrylic groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 896 mPa·s as measured with a rotational viscometer (at 25° C.).

### Example 4

The quantum dot/silsesquioxane copolymer (2) was weighed to contain 20 wt. % quantum dots in terms of the ratio of nonvolatile components, and the crosslinking agent (1) was added as a crosslinking agent such that the molar ratio of mercapto groups in the copolymer to vinyl groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 788 mPa·s as measured with a rotational viscometer (at 25° C.).

### Example 5

The quantum dot/silsesquioxane copolymer (2) was weighed to contain 20 wt. % quantum dots in terms of the ratio of nonvolatile components, and the crosslinking agent (2) was added as a crosslinking agent such that the molar ratio of mercapto groups in the copolymer to vinyl groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 1024 mPa·s as measured with a rotational viscometer (at 25° ° C.).

### Example 6

The quantum dot/silsesquioxane copolymer (3) was weighed to contain 20 wt. % quantum dots in terms of the ratio of nonvolatile components, and the crosslinking agent (2) was added as a crosslinking agent such that the molar ratio of methacrylic groups in the copolymer to methacrylic groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 652 mPa·s as measured with a rotational viscometer (at 25° C.).

### Example 7

The quantum dot/silsesquioxane copolymer (4) was weighed to contain 20 wt. % quantum dots in terms of the ratio of nonvolatile components, and the crosslinking agent (3) was added as a crosslinking agent such that the molar ratio of amino groups in the copolymer to epoxy groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 795 mPa·s as measured with a rotational viscometer (at 25° C.).

### Comparative Example 1

Quantum dots that had only been surface-treated were weighed to contain 20 wt. % quantum dots in terms of the ratio of nonvolatile components, and the crosslinking agent (1) was added as a crosslinking agent such that the molar ratio of mercapto groups in the surface-treated QD solution to vinyl groups in the crosslinking agent was 1:1.

Further, 1 part by mass of Irgacure 1173 was weighed and mixed with 100 parts by mass of the nonvolatile components of this mixture.

Further, propylene glycol monomethyl ether acetate was added as a solvent so as to give a solids concentration of 50%, thus producing an ink composition.

The viscosity of the ink composition was 1393 mPa·s as measured with a rotational viscometer (at 25° C.).

### Comparative Example 2

The solvent in Comparative Example 1 was replaced with toluene to produce an ink composition.

The viscosity of the ink composition was 1411 mPa's as measured with a rotational viscometer (at 25° C.).

Each of the ink compositions obtained in Examples 1 to 7 and Comparative Examples 1 and 2 was ejected onto a glass substrate at a pitch of 150 μm using an inkjet apparatus (LaboJet-600Bio available from Microjet Corporation).

After the ejection, each substrate was irradiated with light of 365 nm wavelength and 500 mW/cm output under an atmosphere of air and cured.

By measuring the pattern remaining on each substrate with a laser microscope (OLS-4100 available from Olympus Corporation), it was confirmed that a dot pattern with an average thickness of 5 μm and a pattern size of 50 μm was formed.

### (Ejection Stability)

Ten patterns in one row were ejected in five consecutive rows. If the ejection became unstable during this continuous operation due to occurrence of a clogging of the nozzle or supply line or an ink ejection failure, the ink composition used was evaluated as being “poor.”

### (Evaluation of Dispersibility)

Agglomerates in the patterns were confirmed by electron microscopy.

The ink compositions that resulted in agglomerates of 1 μm or larger were evaluated as being “poor,” and those that resulted in no agglomerates or agglomerates of less than 1 μm were evaluated as being “good.”

### (Evaluation of Patterning Performance)

The formed island patterns were observed, and the ink compositions that resulted in any defects such as size and shape irregularities of the patterns, missing portions in the patterns, or deviations in pattern size were evaluated as being “poor”.

### (Evaluation of Emission Characteristics of the Formed Patterns)

Using a LabRAM Time Evolution microscope available from Horiba Techno Service, Co., Ltd., the patterned samples fabricated in the above Examples and Comparative Examples were irradiated with a 457 nm laser light (0.03 mW) to measure the photoconverted island pattern area and measure the emission intensity, emission wavelength, and half width of the photoconverted light.

### (Evaluation of Reliability)

The obtained patterns were treated for 250 hours at 85° C. and 85% RH (relative humidity), and the fluorescence emission efficiency after the treatment was measured to confirm the rate of decrease from the initial level and evaluate the reliability.

Tables 1 and 2 show the evaluation results of Examples and Comparative Examples.

TABLE 1

| | | Ex. 1 | Ex. 2 | Ex. 3 | Ex. 4 | Ex. 5 | Ex. 6 | Ex. 7 |
|---|---|---|---|---|---|---|---|---|
| Ejection stability | | Good | Good | Good | Good | Good | Good | Good |
| Evaluation of dispersibility | | Good | Good | Good | Good | Good | Good | Good |
| Evaluation of patterning performance | | Good | Good | Good | Good | Good | Good | Good |
| Evaluation of | Wavelength | 535 nm | 536 nm | 537 nm | 537 nm | 536 nm | 535 nm | 538 nm |
| emission | Half width | 40 nm | 41 nm | 43 nm | 42 nm | 43 nm | 45 nm | 45 nm |
| characteristics | Emission | 42 × 10⁶ | 40 × 10⁶ | 39 × 10⁶ | 39 × 10⁶ | 39 × 10⁶ | 39 × 10⁶ | 36 × 10⁶ |
| | intensity | cps | cps | cps | cps | cps | cps | cps |

| | | | | | | | |
|---|---|---|---|---|---|---|---|
| Evaluation of reliability | −5 | −4 | −6 | −8 | −8 | −8 | −10 |

TABLE 2

| | | Comp. | Comp. |
|---|---|---|---|
| | | Ex. 1 | Ex. 2 |
| Ejection stability | | Poor | Poor |
| Evaluation of dispersibility | | Poor | Poor |
| Evaluation of patterning | | Poor | Poor |
| performance | | | |
| Evaluation of | Wavelength | 540 nm | 540 nm |
| emission | Half width | 40 nm | 41 nm |
| characteristics | Emission | 41 × 10⁶ | 40 × 10⁶ |
| | intensity | cps | cps |

| | | |
|---|---|---|
| Evaluation of reliability | −22 | −18 |

As can be seen from the results shown Tables 1 and 2, Comparative Examples suffered from unstable ejection of the ink composition due to viscosity or agglomeration and a consequent clogging of the nozzle. Consequent pattern defects were also observed.

On the other hand, Examples showed good patterning performance, with stable ejection and no pattern defects.

A comparison of the reliability test results shows that all of Examples have improved stability over Comparative Examples, with less changes over time.

As described above, it was confirmed that the use of the inventive ink composition provides a wavelength conversion material with stable emission characteristics and high reliability.

The present specification includes the following aspects.
[1]: An ink composition containing a quantum dot, comprising:
   a silsesquioxane polymer having the quantum dot copolymerized with silsesquioxane or a silsesquioxane polymer having the quantum dot copolymerized with alkoxysilane.
[2]: The ink composition according to [1], wherein the quantum dot has surface modified with a silane coupling agent.
[3]: The ink composition according to [1] or [2], wherein the alkoxysilane comprises two or more alkoxysilanes with different functional groups.
[4]: The ink composition according to any one of [1] to [3], wherein
   the alkoxysilane comprises at least two or more alkoxysilanes selected from trialkoxysilane, monoalkoxysilane, and dialkoxysilane, and
   the ink composition has a viscosity of equal to or less than 1500 mPa·s.
[5]: The ink composition according to [2], wherein the silane coupling agent has one or more selected from an amino group, a thiol group, a carboxyl group, a phosphino group, a phosphine oxide group, and an ammonium ion.
[6]: The ink composition according to any one of [1] to [5], wherein the silsesquioxane has one or more reactive substituents selected from a vinyl group, an acrylic group, a methacrylic group, a hydroxyl group, a phenolic hydroxyl group, an epoxy group, a glycidyl group, and a thiol group as functional groups.
[7]: The ink composition according to any one of [1] to [6], wherein the alkoxysilane has one or more reactive substituents selected from a vinyl group, an acrylic group, a methacrylic group, a hydroxyl group, a phenolic hydroxyl group, an epoxy group, a glycidyl group, and a thiol group as functional groups.
[8]: A method for producing a color filter, comprising ejecting an ink composition according to any one of [1] to [7]onto a substrate by an inkjet method to form a color filter.
[9]: A method for producing an ink composition, comprising steps of:
   providing a quantum dot;
   providing alkoxysilane; and
   making the alkoxysilane into silsesquioxane attached to a surface of the quantum dot to form a copolymer comprising the quantum dot and the silsesquioxane.
[10]: The method for producing an ink composition according to [9], wherein the step of providing the quantum dot comprises steps of:
   forming a core; and
   forming a shell around the core.
[11]: The method for producing an ink composition according to [9] or [10], wherein the step of forming the copolymer comprises steps of:
   surface-modifying the quantum dot with a silane coupling agent; and
   attaching the silsesquioxane to the surface of the quantum dot via the silane coupling agent.

It should be noted that the present invention is not limited to the above-described embodiments. The embodiments are just examples, and any examples that substantially have the same feature and demonstrate the same functions and effects as those in the technical concept disclosed in claims of the present invention are included in the technical scope of the present invention.

1.-11. (canceled)

12. An ink composition containing a quantum dot, comprising:
a silsesquioxane polymer having the quantum dot copolymerized with silsesquioxane or a silsesquioxane polymer having the quantum dot copolymerized with alkoxysilane.

13. The ink composition according to claim 12, wherein the quantum dot has surface modified with a silane coupling agent.

14. The ink composition according to claim 12, wherein the alkoxysilane comprises two or more alkoxysilanes with different functional groups.

15. The ink composition according to claim 12, wherein
the alkoxysilane comprises at least two or more alkoxysilanes selected from trialkoxysilane, monoalkoxysilane, and dialkoxysilane, and
the ink composition has a viscosity of equal to or less than 1500 mPa·s.

16. The ink composition according to claim 13, wherein the silane coupling agent has one or more selected from an amino group, a thiol group, a carboxyl group, a phosphino group, a phosphine oxide group, and an ammonium ion.

17. The ink composition according to claim 12, wherein the silsesquioxane has one or more reactive substituents selected from a vinyl group, an acrylic group, a methacrylic group, a hydroxyl group, a phenolic hydroxyl group, an epoxy group, a glycidyl group, and a thiol group as functional groups.

18. The ink composition according to claim 12, wherein the alkoxysilane has one or more reactive substituents selected from a vinyl group, an acrylic group, a methacrylic group, a hydroxyl group, a phenolic hydroxyl group, an epoxy group, a glycidyl group, and a thiol group as functional groups.

19. A method for producing a color filter, comprising ejecting an ink composition according to claim 12 onto a substrate by an inkjet method to form a color filter.

20. A method for producing a color filter, comprising ejecting an ink composition according to claim 13 onto a substrate by an inkjet method to form a color filter.

21. A method for producing a color filter, comprising ejecting an ink composition according to claim 14 onto a substrate by an inkjet method to form a color filter.

22. A method for producing a color filter, comprising ejecting an ink composition according to claim 15 onto a substrate by an inkjet method to form a color filter.

23. A method for producing a color filter, comprising ejecting an ink composition according to claim 16 onto a substrate by an inkjet method to form a color filter.

24. A method for producing a color filter, comprising ejecting an ink composition according to claim 17 onto a substrate by an inkjet method to form a color filter.

25. A method for producing a color filter, comprising ejecting an ink composition according to claim 18 onto a substrate by an inkjet method to form a color filter.

26. A method for producing an ink composition, comprising steps of:
providing a quantum dot;
providing alkoxysilane; and
making the alkoxysilane into silsesquioxane attached to a surface of the quantum dot to form a copolymer comprising the quantum dot and the silsesquioxane.

27. The method for producing an ink composition according to claim 26, wherein the step of providing the quantum dot comprises steps of:
forming a core; and
forming a shell around the core.

28. The method for producing an ink composition according to claim 26, wherein the step of forming the copolymer comprises steps of:
surface-modifying the quantum dot with a silane coupling agent; and
attaching the silsesquioxane to the surface of the quantum dot via the silane coupling agent.
